(19) United States
(12) Patent Application Publication
(10) Pub. No.: US 2002/0172363 A1
(43) Pub. Date: Nov. 21, 2002

(54) Data security on a mobile device

(76) Inventors: Timothy M. Dierks, San Francisco, CA (US); Tony Diederich, Menlo Park, CA (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/854,525

(22) Filed: May 15, 2001

(51) Int. Cl. H04L 9/00

(52) U.S. Cl. 380/259

(57) ABSTRACT

The present invention discloses a method whereby all data on such personal computing devices are protected by encryption in a manner transparent to the applications running on the device. The method comprises encrypting all the data records on the device, transparently intercepting all relevant data flow to and from the database, and selectively encrypting or decrypting portions of the data records as needed. Applications running on the device are unaware that the database is encrypted and thus they need not he modified, preserving the existing and future base of investment in applications.

### FIELD OF INVENTION

The present invention relates to the field of cryptography and in particular to improving data integrity on mobile devices.

### BACKGROUND OF THE INVENTION

Personal computing devices, such as a personal digital assistant (PDA), are commonly being used to store information that is both commercially and personally confidential. Such information includes credit card accounts, login IDs, email IDs, checking and savings accounts, and stock accounts. However, should such a device be lost or stolen, all of the information residing thereon must be considered as compromised with the concomitant problems caused by such a compromise.

In the past it has been shown that the Palm OS® platform is inherently insecure, as the platform was not designed around a security framework. Exploits employing security holes are common, such that applications and databases can be accessed or modified by malicious applications or an unauthorized user.

As shipped from the factory, mobile devices, such as a Palm Pilot®, based on the Palm OS platform includes some rudimentary access control managed by a resident security application, The security application allows a user to mark certain records as ‘private’, ideally the records are accessible to a user with a valid predetermined password, or to a well-behaved third-party application in the absence of a password. The same password can also be used to lock the device, so that this password is required to allow access to the device and its subsequent use. The records that are marked as ‘private’ are distinguished by a flag set in the record. Therefore, the onus is on the user to explicitly invoke the locking mechanism in order to gain the benefits of password-controlled access, as bypassing this step makes the data vulnerable.

One of the solutions that has been presented involves the use of third-party security applications to selectively protect data resident on the device. However, oftentimes there is lack of interoperability with other applications. Another drawback of the existing scheme is that ill-behaved or malicious applications can ignore the flag and proceed with reading or modifying the data, as there is no hardware protection to prevent access. One of the many exploits employed by an attacker to read the ‘private’ data from memory involves using hardware-based probes, this exploit works even when the device is locked.

Yet another drawback of the access-control scheme is that passwords can be recovered relatively easily using a number of publicly available tools and techniques. One such password recovery tool is the Proof of Concept tool, available at http://www.atstake.com/research/advisories/2000/eideextract.zip.

Accordingly, it is an object of the present invention to mitigate at least one of the above disadvantages.

### SUMMARY OF THE INVENTION

In accordance wit one of its aspects, the present invention discloses a method whereby data on a personal computing device is protected by encryption in a manner that is transparent to an entity, such as a user or an application, accessing the data records in a database. The method comprises encrypting the data records stored on the device, transparently intercepting all relevant control signals to and from the database, and selectively encrypting or decrypting portions of the data records as needed. The functions of intercepting data flow, which includes control signals such as ‘read’ and ‘write’, are performed by a patch that is placed beneath the application programmable interface (API) layer of the operating system. The patch also includes an encryption module for encrypting the data and a decryption module for decrypting the data in response to the control signals. Therefore, the operation of the device is seemingly unchanged to any entity accessing the data, except for a minor speed reduction, and well-behaved applications automatically gain security while retaining fill compatibility. Applications may read the encrypted data, although the encrypted data will be unusable. Therefore, since the data remains encrypted when not in actual use, the security of tie data is substantially enhanced.

Applications running on the device are unaware that the database is encrypted and thus they need not be modified, which preserves the existing and future base of investment in the applications.

The data records are encrypted with a symmetric-key algorithm using a key generated via pseudo-random input from the user with the key being stored encrypted by a pass-phrase. The symmetric-key algorithm, such as a chained cipher-feed-back (CFB) symmetric-key algorithm, preferably uses a running counter as a tag identifier for use as the initial vector. In addition, the symmetric key may be encrypted with the public key of an administrator, to allow recovery of the encrypted data.

### BRIEF DESCRIPTION OF THE DRAWINGS

These and other features of the preferred embodiments of the invention will become more apparent in the following detailed description in which reference is made to the appended drawings wherein:

FIG. 1 shows a block diagram for improved data security on a device;

FIG. 2 shows a flow diagram outlining the steps of reading an encrypted data record in a memory segment;

FIG. 3 shows a block diagram for a client application wishing to read or write to a specific record; and

FIG. 4 shows a block diagram for synchronizing a database on a personal device with another database on an external storage device, such as personal computer.

### DESCRIPTION OF PREFERRED EMBODIMENTS

In a preferred embodiment a method is provided for controlling access to data stored on a personalized device by cryptographically labeling the data The method protects the data though encryption and allows only certain entities to access the unencrypted data, an entity may include an authorized user of the device. The data is accessed by an entity whenever a record of the data is opened in order to read or write to Me data record. The data record is automatically decrypted for reading or writing in a manner that is transparent to the entity. After reading or writing, the data record is automatically encrypted and it remains in this state until further access.

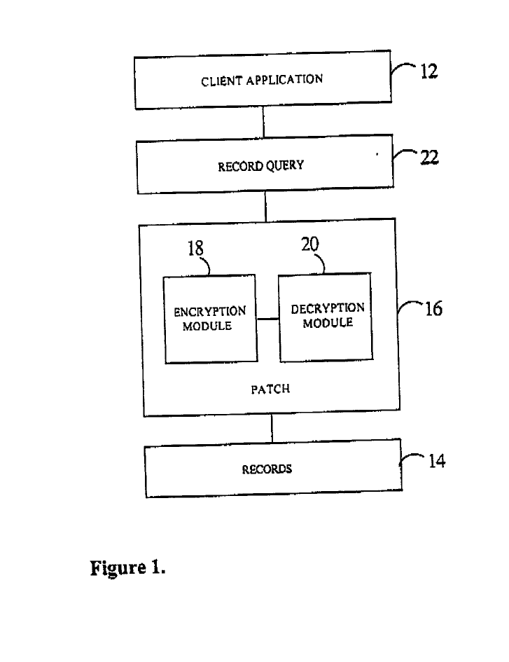

Referring to FIG. 1, which shows a flow chart for accessing data on a device, the device includes a processor and a memory for strong the data. Preferably, the device is a personal digital assistant (PDA) such as a Palm Pilot or a Handspring Visor®. Preferably the device operates on the Palm OS platform, or another suitable platform such as Windows CE or Linux, such that client applications 12 run above the application program interface (API) layer, and the processor controls all instructions between the application and the memory with data records 14.

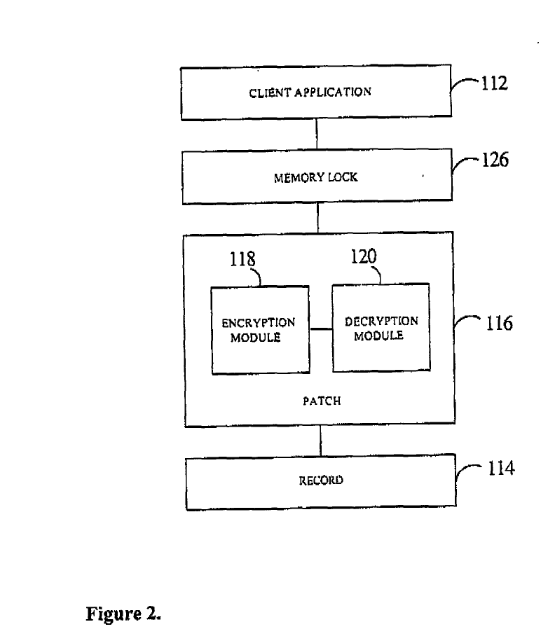

Shown in FIG. 2 is a flow chart by which the functions of the block diagram of FIG. 1 may be better understood. A patch 16 is installed on the PDA to intercept all the system calls between the client application 12 and the memory storing the data records 14, with each data record 14 having a unique identifier. The patch 16 is placed between the API layer and the memory, so that it is transparent to both users and applications 12 on top of the application interface. The patch 16 augments existing system software routines and includes includes an encryption module 18 and a decryption module 20. A client application 12 attempting to read 60 a particular record 14 from the memory passes 65 the uniquely identifier of the record 14 to a record query 22. The record query 22 requests 70 the actual data record 14 via a first system call. The first system call is intercepted 75 by patch 16, and checks 80 the origin and authenticity of the information. If the information is from a tasted source then the patch 16 initiates its own second system call 85, based on the first system call, to records 14 to retrieve the encrypted record. The encrypted record is then decrypted 90 in situ and second system call is allowed to proceed. Therefore, the client application 12 receives 95 an unencrypted version of the record 14 and is thus unaware that the record 14 was stored encrypted. If the system permits, the plaintext version need only exist in the temporary working storage of patch 16 thus allowing the record 14 to remain encrypted in records 40. The client application 10 informs record query 22 after the record 14 has been read 95, at which point, the relevant system call is intercepted by the patch 16 and the record 14 is re-encrypted 100. Similar processes take place should a user or a client application 12 requests to write to a record 14.

The implementation of a preferred embodiment will now be described in detail. The patch 16 can be installed on the PDA so that it resides beneath the API layer, as described above. The patch 16 can be removed from the operating system, if need be.

In order to describe the installation of the patch 16, the memory structure on a mobile device on a Palm OS® platform will now be described. The memory is allocated either as relocatable segments or fixed segments, each segment comprising a contiguous area of bits. The memory segments that store the user's data are the records 14, and the records 14 are linked together in an appropriate manner to form a database. Access to the segments is via the construct of second-level indirection known as a handle, which is essentially a pointer to a memory location, that is, the pointer is used to indirectly access data by address instead of by name via a first-level indirection. The portion of the memory is dedicated to database storage and is controlled by a database manager. The database manager controls read and write access to the various segments by sending appropriate commands to the processor. If faster memory hardware has been employed in portions of the system then one optimization is to avoid writing to the slower memory whenever possible.

Each database record 14 is preceded by a header, which may include information such as the length of the segment, the owner of the database, a unique identifier of the record 14, or the number of unused bits or any combination thereof.

The system calls pertaining to data-access are patched. In a preferred embodiment, system calls made by a client application 12 are intercepted and a check is made as to whether the client application is requesting access to database records 14. If this is indeed the case, the desired records 14 are either encrypted or decrypted as appropriate, at the time before allowing the system call to continue. This behaviour is transparent to both applications and users.

Installation of the patch 16 on to the device operating system includes generating a symmetric key for use by the encryption module 18 and decryption module 20. The patch 16 supplants all the system calls via the well-known mechanism of system traps. A system trap is a processor instruction that triggers a processor exception. When triggered, a selector code that has been passed to the processor is used to calculate which code is to execute next. Each system call in the Palm OS API has a unique selector code and the invocation of the system trap appears to the application as an ordinary function call. The Palm OS includes system calls for the modification of the trap dispatch table By supplying a selector code and a new function pointer, one skilled in the art can supplant the existing responses to the system calls. Upon supplanting of the responses, the encryption module 18 then encrypts all the records 14 in the database, as described below.

Preferably, the symmetric key is generated from random data or pseudo-random data derived from recording stylus movements made by the user on the visual panel of the mobile device. The resulting bit image may then be passed through a secure hash, augmented by further data such as the location of the stylus at given time intervals, and the result passed through a secure hash again to yield the key. Other mechanisms are also possible. The user is then asked to provide a password under which the key is encrypted, possibly by first passing the password through a secure hash. The key is stored encrypted under a key generated from the password and optionally stored encrypted under a public key for archival purposes. The corresponding private key would be in the hands of a security officer or system administrator.

The method of encrypting data records includes using a cipher block in chained cipher-feedback (CFB) mode. The initialization vector for use in the process is a function of the database owner's code and the tag identifier of the record 14, preferably, the tag identifier is a running counter. Other suitable ciphers include triple-DES, Skipjack, Rijndael, amongst others, and the different level of security may be implemented by varying the length of the key.

After the generation of the symmetric key, the records 14 in the database are encrypted in situ and are kept encrypted unless actually being read or written, as described below. If the PDA contains several portions of memory residing in different areas of memory cards, each database of each memory card is examined and records 14 are encrypted.

In operation, the records 14 are protected in a manner transparent to the user and client applications 12 running on the PDA. The following protocol is adhered to by a well-behaved client application 12 wishing to read or write to a specific record 14. Firstly, the client application 12 retrieves a handle to the record 14 via the appropriate system call. Secondly, the handle is passed to another system call that locks the memory associated with the handle and returns a pointer to the now-locked memory. Thirdly, the client application 12 reads or writes to the locked memory. Fourthly, upon completion of the reading or writing, the handle is passed to another system call that unlocks the memory.

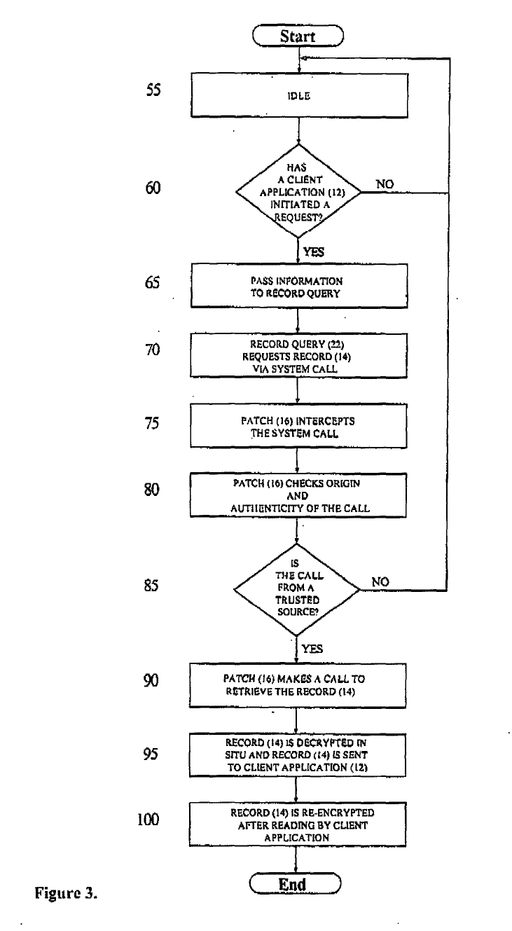

All calls that pass handles and return pointers to the records 14 are intercepted. If the handle in question is associated with a record 14, as opposed to a segment in stack or heap, the record 14 is decrypted in situ if it was originally encrypted and is encrypted if it was originally decrypted. This is described with reference to FIG. 3, which is related to FIG. 1 but with numerals raised by 100 for similar parts. In order for an application 112 to read a record 114, the application 112 makes a system call, passes a handle associated to the record 114, the handle having been previously obtained by a system call that passed the unique identifier of tie record 114. A memory lock 126 makes a memory lock system call to lock the memory segment corresponding to record 140. The fourth system call is intercepted by patch 116, which initiates its own system call to obtain the location of record 114 and decrypts the record 114 in situ, finally allowing the memory lock system call to complete. At the completion of the memory lock system call client application 112 receives back a memory pointer to the location of the newly decrypted record 114.

Since not all pointers are actually associated to records 114, an optimization is obtained by maintaining a list of recently visited handles and pointers associated to records 114. The determination of whether a handle is associated to a record 114 involves analyzing the linked list of records 114 in a given database, and examining the header information of each.

When the client application 112 is finished with the record 114, it passes the previously obtained handle of the record 114 to a system call to notify the Palm OS of the completion of this action. The system call is intercepted by patch 116, in a manner similar to above, resulting in the record 114 being decrypted by a decryption module 120 upon completion of the call, and encryption of the record 114 is performed by an encryption module 118.

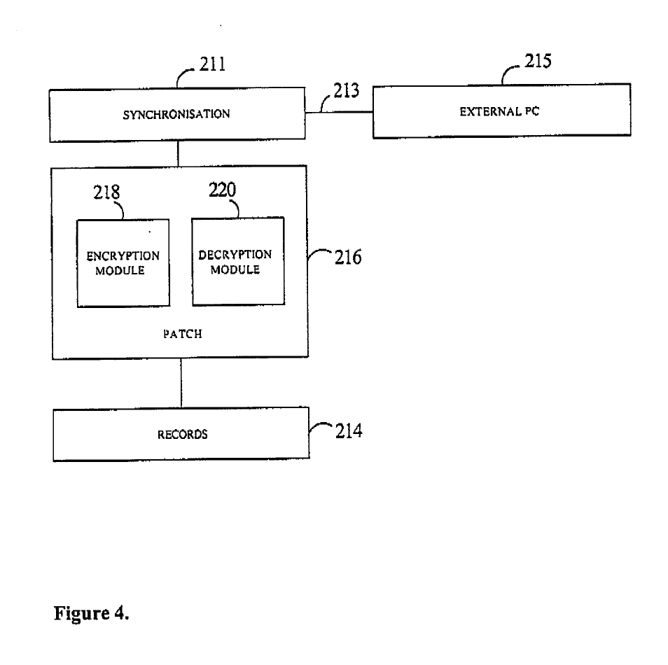

During the course of use of a PDA, the user may wish to synchronize the databases with those residing on an external storage device, such as personal computer (PC). Such activity will result in correct synchronization, as indicated in FIG. 4. Synchronization software 211 establishes a connection 213 with external PC 215 in order to synchronize database with its counterpart on the external PC. The synchronization software 21 1 reads and writes records 214 in database via system calls that are intercepted by patch 216, as described above. The records 214 that pass through the synchronization software 211 are thus decrypted by a decryption module 220, allowing synchronization to occur correctly. After the synchronization, the records 214 are re-encrypted by an encryption module 218 in patch 216.

In another embodiment, communications link 213 is protected by a link-encryption method such as the Transport Layer Security (TLS), the protocol of the IETF, to enhance security

As mentioned above, the patch 16 is preferably removable from the system and this comprises decrypting all the encrypted records and restoring the original system calls. In a manner reverse to that of the installation of the patch 16, all the records 14 in the databases are decrypted in situ. Subsequent to the removal of the patch 16, all the data records 14 are restored to usable and original form for reading and writing.

The above-described embodiments of the invention are intended to be examples of the present invention and alterations and modifications may be effected thereto, by those of skill in the art, without departing from the scope of the invention which is defined solely by the claims appended hereto.

1. A method of controlling access to data stored on a device, the method comprising the steps of:
generating a symmetric key;
encrypting said data by performing a first mathematical operation on said data, said first mathematical operation associated with said symmetric key;
intercepting control signals requesting access to said data;
decrypting said data by selectively performing a complimentary second mathematical function on said data, said complimentary second mathematical operation associated with sad symmetric key; and
maintaining data in encrypted form until access thereto is requested.

2. The method of claim 1, wherein said data includes logically linked data records to form a database.

3. The method of claim 1, wherein said symmetric key is generated from random data received from recording stylus movements performed by a user.

4. The method of claim 3, wherein said stylus movements form a bit image, said bit image being used in the generation of said symmetric key.

5. A method of sewing data on a personalized device comprising the steps of.
generating a secure symmetric key;
encrypting said data with said secure symmetric key, in accordance with an the predetermined algorithm;
storing said data in encrypted form until a request for read and write access is made;
decrypting said data with said secure symmetric key for read and write access; and
encrypting said secure symmetric key with a public key.

6. A method of claim 5, whereby the step of generating a secure symmetric key includes a plurality of different degrees of key length, said key length associated with level of security.

7. The method of claim 6, wherein said predetermined algorithm is selected from a group of mathematical operations.

8. The method of claim 7, wherein said mathematical operations are DES, triple DES, Skipjack and Rijndael.

9. The method of claim 7 and 8, wherein said level of security is depends on selected mathematical operation.

10. A method of securing stored data on a mobile computing device and controlling access to said stored data by a use, said method comprising the steps of:
associating said stored data with a plurality of unique identifiers;
encrypting said stored data by performing a mathematical operation thereon, and maintaining said stored data in encrypted format;
initiating a fir call to access said stored data to a processor, said first call including a unique identifier;
intercepting said first call to assess level of privilege associated with said user,
manipulating said first call in accordance with said level of privilege to generate a second call to said processor, said second call including said unique identifier;
communicating second call to said stored data to access said stored data associated with said unique identifier;
decrypting said stored data associated with said unique identifier by performing a complimentary mathematical operation to said stored data, said step of decrypting said stored data in accordance with said level of privilege;
communicating said decrypted stored data associated with said unique identifier to said user; and
encrypting said stored data with said mathematical operation subsequent to access by said user.

11. The method of claim 10, wherein the step of controlling access includes steps of. a client application retrieving a handle to a record in a memory segment via a first call;
passing the handle to second call to lock said memory segment associated with the handle;
the handle returning a pointer to client application, said pointer associated with said locked memory segment;
the client application reading or writing to the locked memory segment; passing said handle to third call to unlock the locked memory segment, upon completion of said reading or writing.

12. The method of claim 11, wherein the step of controlling access further includes a step of optimizing access to the data records, said step including maintaining an access list of recently accessed pointers and handles.

13. A improved data security system on a portable device, said system having:
a data storage unit for storing said data, said data having data records and said each of said data records associated with a unique identifier;
a processor for executing predetermined instructions belonging to a predetermined instruction set, said instruction set associated with access instructions to said records;
a patch for preventing execution of received predetermined instructions, and for verifying origin of said received instructions, and for further generating new instructions associated with said received predetermined instructions, upon verification thereof;
whereby a data record is accessed by initiating an instruction with the unique identifier of the data record to be accessed to the processor, said instruction being intercepted and converted into a new instruction by said patch upon verification of origin.

14. A method of claim 1, wherein the method fisher includes the steps of synchronizing a database on said device with a database on another device.
